(19) United States
(12) Patent Application Publication
(10) Pub. No.: US 2008/0231049 A1
(43) Pub. Date: Sep. 25, 2008

(54) INTEGRATED SEAL GLAND AND COUPLER ASSEMBLY

(75) Inventors: Christina M. Schober, Saint Anthony, MN (US); David D. Nguyen, Savage, MN (US); Robert M. Bowman, Plymouth, MN (US)

Correspondence Address: HONEYWELL INTERNATIONAL INC.;PATENT SERVICES AB-2B, 101 COLUMBIA ROAD, P.O. BOX 2245, MORRISTOWN, NJ, 07962-2245, US

(73) Assignee: HONEYWELL INTERNATIONAL INC., Morristown, NJ (US)

(21) Appl. No.: 11/689,347

(22) Filed: Mar. 21, 2007

(51) Int. Cl. F16L 15/04

(52) U.S. Cl. 285/390

(57) ABSTRACT

Systems and methods for supplying gas to a laser block assembly (LBA). An example system includes a reusable base component and a splitable fill tube with integrated seal head. The base component is attached to a gas supply device. The fill tube is frit bonded to the LBA. The reusable base components includes an internally threaded base section and an externally threaded nut, and the fill tube includes a first end that is secured within the base section when the nut is screwed into the base section. The fill tube is mechanically pinched to make a seal after gas processing has been supplied to the LBA.

### BACKGROUND OF THE INVENTION

Current assembly of a metal gasket face seal fitting, such as a VCR® flange, requires that the person assembling must hold and turn both sides of the assembly. Normally, this is done manually to finger tight and then wrenches are used to make a better seal. The current method is not ergonomic and operator friendly, it requires manual dexterity and/or a separate holding fixture. It also requires a multiple component sub-assemblies that are costly and may require additional processing. Because of this, the time for attaching a gas supply device to a laser block assembly (LBA) is time consuming and therefore, costly.

Therefore, there exists a need for improving the efficiency of attaching a gas supply device to a laser block assembly.

### SUMMARY OF THE INVENTION

The present invention provides systems and methods for supplying gas to a laser block assembly. An example system includes a reusable base component and a splitable single material fill tube with integrated seal gland. The reusable base component is attached to a gas supply device. The fill tube is frit bonded to the laser block assembly and the reusable base component is partially secured within the base component. The base component includes an internally threaded base section and an externally threaded nut, and the fill tube includes a first end that is secured within the base section when the nut is screwed into the base section. The fill tube is mechanically pinched to make a seal after vacuum processing and final laser fill gas (gas processing) is supplied to the laser block assembly.

The fill tube and the base section include sealing heads. When the nut is securely attached to the base, a seal is formed between the fill tube sealing head, a washer, and sealing head within the base.

In one aspect of the invention, a torque limiter includes a first component that may be secured within the base, and a second component that is received around the fill tube. The torque limiter is used to minimize rotational motion of the fill tube which is attached to the laser block assembly.

### BRIEF DESCRIPTION OF THE DRAWINGS

Preferred and alternative embodiments of the present invention are described in detail below with reference to the following drawings:

FIG. 1 illustrates a side view of a gas supply device that is attached to a laser block assembly during the fill process of a laser block assembly;

FIG. 2 illustrates an exploded view of a coupler assembly used in linking the gas supply device and the laser block assembly as shown in FIG. 1;

FIG. 3 illustrates a cross-sectional view of an exploded view along a longitudinal axis of the coupler assembly;

FIG. 4 illustrates a cross-sectional view, non-exploded perpendicular to the longitudinal axis of the coupler assembly; and

FIG. 5 illustrates a cross-sectional, non-exploded view along the longitudinal axis of the coupler assembly.

### DETAILED DESCRIPTION OF THE PREFERRED EMBODIMENT

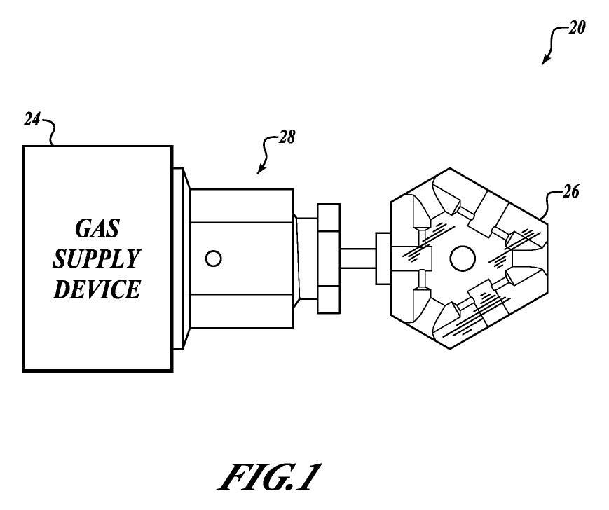

FIG. 1 illustrates a side view of a system 20 formed in accordance with the present invention. The system 20 shows a gas supply device 24 that is attached to a laser block assembly (LBA) 26 via coupler assembly 28 during a gas fill stage of LBA manufacturing. The coupler assembly 28 is attached to the gas supply device 24 via any of a number of various methods, for example using an annular clamping device (not shown). The coupler assembly 28 includes a one-time use fill tube 40 that is frit bonded to the LBA 26 and mechanically pinched and sealed after gas processing of the LBA 26.

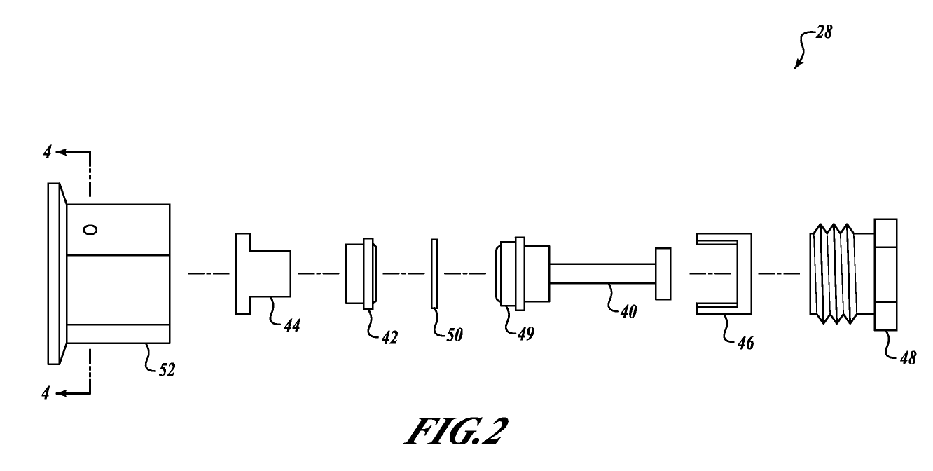

FIG. 2 illustrates an exploded view of the coupler assembly 28. The coupler assembly 28 includes a base 52 that receives a torque limiter 44 and a first sealing head 42. The sealing head 42 and optionally the torque limiter 44 are secured (welded) within the base assembly 52. During the assembly of the coupling to the gas supply device 24 and base 28, a deformable washer 50 is held in place by a second torque limiter 46. The second torque limiter 46 is held captive within the base 52 between a flange on the fill tube 40 and a securing cap nut 48. The cap nut 48 includes threads that are received by threads within a cavity in the base 52. When the cap 48 is tightened within the base 52, a second sealing head 49 that is part of the fill tube 40 is pressed against the washer 50 and the first sealing head 42 in order to provide a seal within the coupler assembly 28. The washer 50 is formed of copper or some other comparable deformable material.

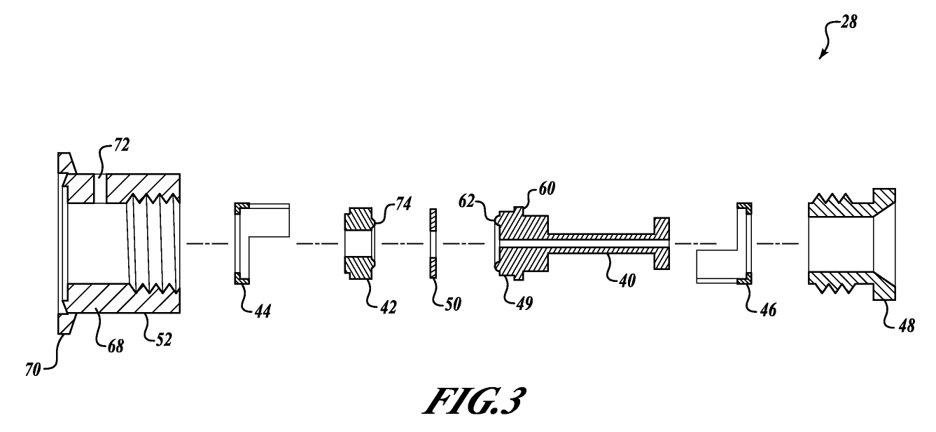

FIG. 3 illustrates a cross-sectional, exploded view of the coupler assembly 28 at a vent hole 72 located in the base 52. The base 52 includes internal threads that extend through just a portion of the internal cavity of the base 52. In one embodiment, the base 52 includes a first section 68 that includes the internally threaded cavity and has an external surface comprised of six sides (hex head). Other nut/wrench configurations may be used, e.g., 4 sided, 7 sided, etc. The base 52 also includes a second section 70 that provides a circular flange that is welded or somehow otherwise attached to the first section 68. The second section 70 is used for attaching to components of the gas supply device 24. Also, the vent hole 72 is normally used to verify vacuum seal integrity.

The first torque limiter 44 may be secured to the base 52 in such a manner as to inhibit spinning within the base 52. The first sealing head 42 includes a raised circular bead (seal gland) 74 that has a predefined diameter. The second sealing head 49 that is part of the fill tube 40 also includes a raised circular bead (seal gland) 62 that has the same diameter as the seal gland 74 of the first sealing head 42. The second sealing head 49 also includes an annular flange 60 that contacts the second limiter 46. The flange 60 and the second torque limiter 46 have a diameter that is similar to a base edge of the nut 48. Thus, as the nut 48 is tightened into the base 52, the base edge of the nut 48 applies pressure to the second torque limiter 46 and the second sealing head 49, thereby forcing the seal gland 62 of the second sealing head 49 to put pressure on the washer 50 and thus the seal gland 74 of the first sealing head 42. A second end of the nut 48 includes a hexagonal head. Therefore, for an operator to tighten the device to the position as shown in FIG. 5, the operator would only need two wrenches; one to be used on the base 52 and the other to be used on the nut 48.

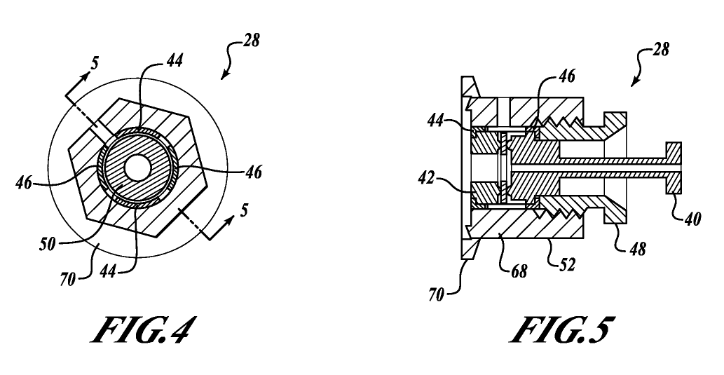

As shown in FIG. 4, the washer 50 rests in place by the torque limiters 44, 46 in the non-thread section of the first section 68. As the nut 48 is tightened to the base 52 the blades of the torque limiters 44, 46 engage. The first torque limiter 44 keeps the second torque limiter 46 from moving, thus keeping the fill tube 40 from rotating as the nut 48 is being tightened. After the coupler assembly 28 has been formed as shown in FIG. 5, it is attached to the gas supply device 24. In one embodiment, the base 52 of the coupler assembly 28 is semi-permanently attached to the gas supply device 24. Next, the end of the fill tube 40 that exits the coupler assembly 28 is frit bonded to the LBA 26 at about 460° C. Then, the gas supply device 24 is activated for vacuum processing and gas filling the LBA 26 with the desired gas composition. After the desired quantity of gas has been inserted into the LBA 26, a pinching device (not shown) mechanically pinches a neck portion of the fill tube 40 to seal the gas within the LBA 26. Then, the LBA 26 is sent on to a next stage in the manufacturing process.

After the fill tube 40 has been pinched to seal the gas within the LBA 26, the nut 48 is removed and the remaining portion of the fill tube 40 is discarded. The fill tube 40 is formed of an iron-nickel (FeNi) alloy, such as Carpenter 49, or a comparable material. The other components of the coupler assembly 28 are formed of stainless steel or some other comparable material. Also, the washer 50 that was used in the previous fill process is discarded. The washer 50 may be formed of materials such as copper, nickel or stainless steel.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A coupler assembly for use in a gas supply process for a laser block assembly, the device comprising:
a reusable base component configured for attachment to a gas supply device; and
a splitable fill tube with integrated seal gland,
wherein the fill tube is frit bonded to the laser block assembly and the reusable base component holds the fill tube in place during a gas filling process of the laser block assembly.

2. The device of claim 1, wherein the base component includes an internally threaded base section and an externally threaded nut, and the fill tube includes a first end that is secured within the base section when the nut is screwed into the base section.

3. The device of claim 2, wherein the base section includes a sealing head.

4. The device of claim 3, further comprising a washer,
wherein the fill tube includes a sealing head, wherein when the nut is securely attached to the base section, a seal is formed between the fill tube sealing head, the washer, and sealing head within the base.

5. The device of claim 4, wherein an external surface of the base section and the nut have two or more flat sides.

6. The device of claim 4, further comprising a torque limiter.

7. The device of claim 6, wherein the torque limiter includes a first component that is secured within the base section, and a second component that is received around the fill tube.

8. The device of claim 1, wherein the splitable fill tube includes a neck portion, the neck portion is mechanically pinched to make a seal after gas processing of the laser block assembly.

9. A method for supplying gas to a laser block assembly, the method comprising:
attaching a reusable base component to a gas supply device;
securing a sealing head of a splitable fill tube within the reusable base component;
frit bonding the splitable fill tube to the laser block assembly; and
supplying gas to the laser block assembly via the reusable base component and the splitable fill tube.

10. The method of claim 9, wherein the base component includes an internally threaded base section and an externally threaded nut, and the fill tube includes a first end that is secured within the base section when the nut is screwed into the base section.

11. The method of claim 10, wherein the base section includes a sealing gland.

12. The method of claim 11, wherein securing includes forming a seal between the fill tube sealing head, the washer, and sealing head within the base section.

13. The method of claim 12, wherein an external surface of the base section and the nut have two or more flat sides

14. The method of claim 12, wherein securing includes limiting rotational movement of the fill tube during securing to a gas supply device.

15. The method of claim 9, further comprising mechanically pinching the splitable fill tube to make a seal after gas processing of the laser block assembly.
